(19) United States
(12) Patent Application Publication
(10) Pub. No.: US 2009/0211982 A1
(43) Pub. Date: Aug. 27, 2009

(54) PROCESS FOR TREATING EFFLUENT LIQUID FRACTION FROM POST ANAEROBIC DIGESTION

(75) Inventor: Stephen D. Allen, Eagle, ID (US)

Correspondence Address: KIRTON AND MCCONKIE, 60 EAST SOUTH TEMPLE,, SUITE 1800, SALT LAKE CITY, UT, 84111, US

(73) Assignee: WATER SOLUTIONS, INC., Sioux Falls, SD (US)

(21) Appl. No.: 12/391,084

(22) Filed: Feb. 23, 2009

Related U.S. Application Data
(60) Provisional application No. 61/030,800, filed on Feb. 22, 2008.

(51) Int. Cl. C02F 1/52; C02F 1/56

(52) U.S. Cl. 210/666; 210/728; 210/727

(57) ABSTRACT

A process for treating a liquid fraction of effluent wastewater from post anaerobic digestion containing fine solids having a size less than about 25 microns is disclosed. A metal salt flocculant is added to the liquid fraction in an amount ranging from about 50 to 500 ppm in the liquid fraction. The metal salt flocculant is selected from inorganic iron and aluminum flocculent compounds having a +2 or +3 valence. A cationic organic polymer is added to the liquid fraction in an amount ranging from about 10 to about 150 ppm in the liquid fraction. The cationic organic polymer has a molecular weight greater than about 3,000,000 and cationicity in the range form 1.25 mole % to 30 mole %. The metal salt flocculent and the cationic organic polymer produce a separable solid fraction which is recovered. Pre-treatment with a small amount of the cationic organic polymer provides improved results.

### CROSS-REFERENCE TO RELATED APPLICATION

This application claims the benefit of U.S. Provisional Patent Application No. 61/030,800, filed Feb. 22, 2008, which is incorporated by reference.

### FIELD OF THE INVENTION

The present invention is directed to a process for treating the liquid fraction from the effluent waste stream of a post anaerobic digestion process. More particularly, the present invention includes a process for removing contaminants from the liquid fraction which may include fine solids as well as nitrogen, phosphorus, and potassium chemical compounds.

### BACKGROUND OF THE INVENTION

In recent years, anaerobic digesters are proliferating in the United States and abroad. The growth of the industry is increasing in popularity as the carbon credits and “manure to power” industry has evolved and grown. The creation of energy (electrical conversion and heat) from methane generated by the anaerobic conversion of organic matter in the wastewater has been documented and is well understood.

Anaerobic digesters may have an input stream containing up to 12% or 13% organic solids. A purpose of the digester is to convert (destruct) a portion of the solids into methane. A typical anaerobic digester may destroy 50% to 65% of the solids, depending on operating conditions and efficiency of the system. Some systems may destroy up to 75% of the solids, while poorly operated digesters may only destroy 30% of the solids. Thus, a typical effluent waste stream from an anaerobic digester may contain from about 3% to 8% solids. The amount of effluent solids may vary from this range depending upon feed solid values and operating efficiency. These solids are post digestion, and as such may contain, but are not limited to, high chemical oxygen demand (COD) and high biological oxygen demand (BOD) wastewater. In addition, the organic fractions present have been partially or completely destructed to yield organic fragments, all of which contribute to the general undesirable nature of the post anaerobic digester effluent. Some states are promulgating (and currently regulating) the containment of these wastewaters for extended periods as the volume and the contaminant loading have and remain a contributory causative effect in the deterioration of the quality of the aquifers, water sheds, streams and wet lands, from continuous irrigation and discharge of the high contaminant loaded wastewater.

The effluent solids may be divided into those that have a size greater than about 300 microns and solids having a size less than about 25 microns (μm). The fraction of larger solids (>300 μm), may represent about 60% of the total solids, and the fraction of fine solids (<25 μm), may represent about 40% of the total solids. The larger solids are usually removed using conventional mechanical separation processes. Such mechanical separation processes include, but are not limited to, centrifuge, screen press, belt press, and other industrial separation processes known in the art.

The solids from this separation are saleable as bedding, mulch and if the contaminants are high enough, as soil amendments or fertilizer. The remaining liquid fraction may typically contain less than about 2% solids, of which the solids represent fine solids having a size less than about 25 μm are typically impounded in a confinement pond. The liquid fraction typically contains nitrogen, phosphorous, and potassium compounds as well as micronutrient solids. This liquid fraction is clean enough for reuse as wash water or irrigation water, but as is evident from the intermediate loading values, unusable for other applications as it still contains high COD and BOD values as well as other contaminants rendering it unfit for a myriad of tasks within the process operations. The largest problem from the possible reuse of this water as wash or irrigation or for cleaning applications is the gradual build up of the contaminates present as the solids elimination step is limiting, that is, it only removes the larger solids fraction (>300 μm) and the fine solids (<25 μm) remain. Over time, the buildup of fine particulates can create additional problems requiring the effluent from the reaction be completely discharged to a confinement pond or holding area. Accepted practices of nutrient management for the post digester effluents prevent continued use over time as the nitrogen and phosphorous buildups are unacceptable.

There are currently 104 (or more) anaerobic digesters located in the United States and/or a greater number in Europe, Canada and South America. Each of the digesters yields an effluent that is high in contaminants and in solids content, all of which have a value, a value for the solids and a value for the potentially reusable water from the process stream. To date, no system has been described that addresses the solids separation or the cleaning of the effluent water for reuse in the process from which the anaerobic digestion is employed.

The industries to which this technology would apply include, but are not limited to, dairies, bovine confinement, porcine confinement and birthing processes, poultry confinement, industrial processes where anaerobic digestion is employed, such as animal processing, food, ethanol and general food processors where a digestible wastewater is generated.

It will be appreciated that there is a need in the art to treat the liquid fraction from post anaerobic digestion to remove contaminants and solids, thereby to recover potentially valuable constituents. It would be an advancement in the art to provide an apparatus and process for treating effluent liquid fraction from post anaerobic digestion to clean the effluent liquid fraction and make it a clean renewable recyclable effluent for reuse or irrigation.

### SUMMARY OF THE INVENTION

The present invention provides a process for treating a liquid fraction of effluent wastewater from post anaerobic digestion. More particularly, the present invention provides a process for removing contaminants from the liquid fraction which may include fine solids as well as nitrogen, phosphorus, and potassium chemical compounds. As used herein, the liquid fraction is obtained following mechanical separation of larger solids (greater than about 300 μm) from the effluent waste stream from an anaerobic digester. The liquid fraction may typically contain less than about 2% solids, of which the solids represent fine solids having a size less than about 25 μm. The pH of the liquid fraction may typically range from about 6.8 to 7.4, depending on the operating conditions of the anaerobic digester.

One non-limiting embodiment within the scope of the invention includes a process for treating a liquid fraction of effluent wastewater from post anaerobic digestion. In the process, a metal salt flocculant is added to the liquid fraction. The metal salt flocculant may be added in an amount ranging from about 50 to 500 ppm in the liquid fraction. In some embodiments the metal salt flocculant may be added in an amount ranging from about 50 ppm to 250 ppm in the liquid fraction. The metal salt flocculant may be selected from inorganic iron and aluminum flocculant compounds having a +2 or +3 valence. In some embodiments, the metal salt flocculant may be selected from inorganic aluminum flocculant compounds having a +3 valence. In some embodiments, the metal salt flocculant may be selected from polyaluminum chloride (PAC), aluminum chlorohydrate, aluminum sulfate, calcium aluminate, aluminum and sodium silicates, ferrous and ferric chlorides and sulfates, and analogs thereof.

In the process, a cationic organic polymer is added to the liquid fraction. The cationic organic polymer may be added in an amount ranging from about 10 ppm to about 150 ppm in the liquid fraction. The cationic organic polymer may have a molecular weight greater than about 3,000,000. In some embodiments, the cationic organic polymer may have a molecular weight greater than about 5,000,000. The cationic organic polymer may have a cationicity in the range form 1.25 mole % to 30 mole %. The cationic organic polymer may have a cationicity in the range form 1.25 mole % to 20 mole %. The cationic organic polymer may have a cationicity in the range form 1.25 mole % to 10 mole %. The cationic organic polymer may have a cationicity in the range form 1.25 mole % to 5 mole %. The cationic organic polymer may have a cationicity in the range form 1.25 mole % to 2.5 mole %. The cationic organic polymer may include a dimethyl nitrogen-based quaternary moiety to provide its cationicity. In some embodiments, the cationic organic polymer is selected from polyacrylamide, Mannich polymers, diallyl dimethyl ammonium chloride (DADMAC), epi-dma, and mixtures thereof. In some embodiments, the cationic organic polymer is selected from diallyl dimethyl ammonium chloride (DADMAC), epi-dma, and mixtures thereof. Due to the high molecular weight of the cationic organic polymer, the cationic organic polymer may be dry.

The metal salt flocculant and the cationic organic polymer produce a separable solid fraction in the liquid fraction. The separable solid may be removed from the liquid fraction to form a treated liquid fraction. The separable solid fraction may be separated from the liquid fraction by a mechanical separation technique. Examples of mechanical separation techniques that may be used include, but are not limited to, belt press, centrifuge, filter press, and other industrial separation processes known in the art.

In the process, the treated liquid fraction may optionally be passed through a carbon filter or a combination of carbon and activated bentonite clays to provide ammonia removal and clarity of the liquid fraction.

In another non-limiting embodiment within the scope of the invention, the liquid fraction is pre-treated with a small amount of pre-treatment cationic organic polymer prior to adding the metal salt flocculant. The pre-treatment cationic organic polymer includes the same class of cationic organic polymers as defined above. In practice, it may be the same or different as the cationic organic polymer. The pre-treatment cationic organic polymer may be added in an amount ranging from about 10 ppm to about 30 ppm in the liquid fraction. The pre-treatment cationic organic polymer reacts with the fine solids to produce a separable fine solid fraction in the liquid fraction. In some embodiments, the separable fine solid fraction is removed from the liquid fraction. Mechanical separation techniques, such as those disclosed above, may be used.

In the embodiment using a pre-treatment cationic organic polymer, the amount of metal salt flocculant added to the liquid fraction may be reduced by about ⅓. In some embodiments, the metal salt flocculant may be added to the liquid fraction in an amount ranging from about 50 to 100 ppm in the liquid fraction.

A cationic organic polymer may be added to the liquid fraction as disclosed above. In some embodiments, the amount of cationic organic polymer added to the liquid fraction may range from about 10 to about 150 ppm in the liquid fraction. The cationic organic polymer in this pre-treatment embodiment includes the same class of cationic organic polymers as defined above. The metal salt flocculant and the cationic organic polymer produce a separable solid fraction in the liquid fraction, which may be removed to form a treated liquid fraction, as described above.

In the pre-treatment process, the treated liquid fraction may optionally be passed through a carbon filter or a combination of carbon and activated bentonite clays, as disclosed above.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a photograph showing the raw from post anaerobic digester waste stream effluent, an intermediate processed liquid fraction, and the final processed liquid fraction.

FIG. 2 shows a Static Buchner funnel drainage curve to determine the achievable discharge solids from a belt filter press.

FIG. 3 includes photographs of the screened solids from the raw sludge sample “A” based upon particle size. Photo #1, +30 mesh; photo #2, 30×50 mesh; photo #3, 50×100 mesh; photo #4, 100×150 mesh; photo #5, 150×230 mesh; photo #6, 230×325 mesh.

FIG. 4 shows a possible schematic configuration of a treatment system for use within the scope of the invention.

### DESCRIPTION OF THE INVENTION

The present invention discloses a process for removing contaminants from the liquid fraction of a post anaerobic digestion waste stream. The liquid fraction may include fine solids as well as chemical and nutrient contaminants. The separation of the fine solids may be achieved in a multistep process. One preferred embodiment includes addition of a metal salt flocculant and a cationic organic polymer to form a separable solid. Another preferred embodiment includes addition of a pre-treatment cationic organic polymer to form separable solids and removal of the solids. The remaining liquid fraction is them further treated by addition of a metal salt flocculant and a cationic organic polymer to form more separable solids. Such solids are removed using known and novel separation techniques, including but not limited to belt press, centrifuge, filter press, etc. Non-limiting examples of the metal salt flocculant and cationic organic polymer that may be used in the disclosed process are described above.

The solids formed by this reaction may be separated by any known or novel separation system including, but not limited to belt press, by centrifuge, or by filter press. Continuous processes are preferred, but batch-type treatment may still be used. Any of the conventional separation systems will work to separate out the solids from the liquid.

The liquid fraction from an anaerobic digester effluent waste stream is processed according to the invention disclosed herein eliminate contaminants from the liquid fraction. This is accomplished by the addition of a metal salt flocculant and a cationic organic polymer. The flocculant may include, but is not limited to, iron and aluminum compounds having a +2 or +3 valence. Examples of suitable flocculants include, but are not limited to, polyaluminum chloride (PAC), aluminum chlorohydrate, aluminum sulfate, calcium aluminate, aluminum and sodium silicates, ferrous and ferric chlorides and sulfates, and analogs thereof. The cationic organic polymer may include a dimethyl nitrogen-based quaternary moiety to provide its cationicity. The cationic organic polymer may contain from about 1.25 to 30 mole percent cationic charge. In some preferred embodiments, the cationic organic polymer may have a cationicity in the range form 1.25 mole % to 20 mole %. The cationic organic polymer may have a cationicity in the range form 1.25 mole % to 10 mole %. The cationic organic polymer may have a cationicity in the range form 1.25 mole % to 5 mole %. The cationic organic polymer may have a cationicity in the range form 1.25 mole % to 2.5 mole %. The cationic organic polymer may include, but is not limited to, such as a DADMAC, epi-dma, or Mannich polymers.

Almost any cationic organic polymer will suffice. Low toxicity polymers are preferred to limit contamination of the solids recovered by the process. Such low toxicity polymers include cationic organic polymers that have low residual monomer content. Molecular weights may range from 3 to 5 million to 14 million or more. The cationic polymers may be water soluble, such as the DADMAC and epi-dma polymers. The cationic polymers may in the form of an emulsion (typically with molecular weights in the range of about 3 to 5 million), and the cationic polymers may be dry (molecular weight greater than about 5 million) or typical high molecular weight Mannich polymers.

Following reaction of the metal salt flocculant and the cationic organic polymer, the resulting solids are removed. The remaining liquid fraction is preferably then passed through a active carbon filter or a combination of carbon and activated bentonite clays for ammonia removal and clarity of the solution depending on the quality of the water required for the applications. For example, this process yields water for cleaning, water for recycle, and water that may be further treated by reverse osmosis or ultrafiltration that is capable of being used for cattle watering directly and a number of nonfood contact applications. Each liquid fraction stream may be treated separately for the particular need.

Useful results are obtained by the pre-treatment of the liquid fraction with a small amount of cationic organic polymer. The pre-treatment cationic organic polymer may be added in an amount ranging from about 10 ppm to about 30 ppm in the liquid fraction. This amount may vary depending upon the fine solids content. The pre-treatment cationic organic polymer reacts with the fine solids to produce a separable fine solid fraction in the liquid fraction. In some embodiments, the separable fine solid fraction is removed from the liquid fraction. Mechanical separation techniques, such as those disclosed above, may be used.

In the embodiment using a pre-treatment cationic organic polymer, the amount of metal salt flocculant added to the liquid fraction may be reduced by about ⅓. In some embodiments, the metal salt flocculant may be added to the liquid fraction in an amount ranging from about 50 to 100 ppm in the liquid fraction. A cationic organic polymer may be added to the liquid fraction as disclosed above. In some embodiments, the amount of cationic organic polymer added to the liquid fraction may range from about 10 to about 150 ppm in the liquid fraction. The liquid fraction may be further treated by passing through an active carbon filter or a combination of carbon and activated bentonite clays.

The following examples are given to illustrate various embodiments within the scope of the present invention. These are given by way of example only, and it is understood that the following examples are not comprehensive or exhaustive of the many types of embodiments of the present invention that can be prepared in accordance with the present invention.

### EXAMPLE 1

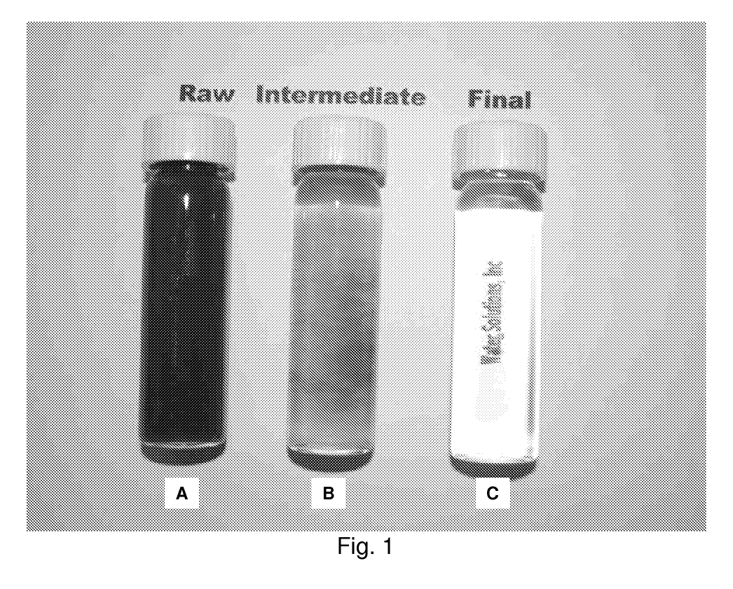

The reaction of ferric sulfate and a Ciba cationic polymer (dry, cationic acrylamide polymer, about 6 million molecular weight, diluted in a liquid form) yields separable solid, which upon removal from the liquid fraction results in the “Intermediate” liquid fraction illustrated in FIG. 1, “B” and described in Table 1. The “Intermediate” liquid fraction may be passed through an active carbon filter or combination of active carbon filter and bentonite clay filter. The column “Processed-1” reports the results of passing the “Intermediate” liquid fraction through an active carbon filter. The column “Processed-2” reports the results of passing the “Intermediate” liquid fraction through a combination of active carbon filter and bentonite clay filter. This “Final” liquid fraction, illustrated in FIG. 1 as “C” was very clear and showed neglibible TSS, no BOD, and low ammonia content.

TABLE 1

| | Raw | Intermediate | | Processed - 1 | | Processed - 2 |
|---|---|---|---|---|---|---|
| TSS | 2.24% | 244 | mg/L | <10 | mg/L | <3 mg/L |
| Total | 2.90% | <300 | mg/L | <40 | mg/L | |
| Solids | | | | | | |
| TDS | | 4,900 | | 7,150 | | |
| COD | >20,000 mg/L | >1,900 | mg/L | 500 | mg/L | |
| BOD | >10,000 mg/L | 1,690 | mg/L | <50 | mg/L | N.D. |
| TOC | | 725 | mg/L | 76 | mg/L | |
| NO₃ | | 0.2 | mg/L | 0.02 | mg/L | |
| NH₃ | | 1140 | mg/L | 980 | mg/L | 134 mg/L |
| PO₄ | | 1.3 | mg/L | 0.09 | mg/L | |

| | | | |
|---|---|---|---|
| pH | 7.9 | 7.7 | 8.2 |

### EXAMPLE 2

Various polymers were tested to evaluate their ability to flocculate a post-anaerobic digester sludge sample. Two polymers, a Mannich polymer C-341 (high molecular weight dry cationic organic polymer) and Super Alta (a dry cationic organic polymer with mixed charge densities and molecular weight ranging from about 7 to about 12 million), were tested along with polymers used in cow and pig manure samples. None of the polymers tested by themselves were able to flocculate the sludge to a level consistent with discharge to environment or reuse for anything other than land application.

Ferric chloride (38.4% solution, 1.392 S.G.) was added to the sludge sample prior to polymer addition. The optimum ferric chloride dosage rate was 342 lbs/ton SS. The ferric chloride dosage is preferably in the range from 100 to 500 ppm, and more preferably in the range of 250 to 300 ppm. After ferric chloride, a mixing and reaction time of 90-120 seconds was required before the pH and foaming stabilized and the polymer could be added. The pH of the sample lowered from 7.9 to 6.1 after ferric chloride addition.

The Mannich polymer, C-341, was effective in flocculating the sludge after the addition of ferric chloride. The recommended dosage rate for C-341 was found to be 17.7 active lbs/ton for a belt filter press (BFP) application and 23.4 active lbs/ton for a centrifuge application.

After flocculation with ferric chloride and the Mannich Polymer C-341, BFP simulations of an Andritz 1.0 m SMX®-S8 BFP were conducted at a simulated throughput of 634 lbs/hr. Cake dryness of 18.4% TS was achieved from the simulations with 342 lbs/ton SS of ferric chloride and 505 lbs/ton neat (17.7 active lbs/ton @3.5% active).

Centrifuge spin-down testing was conducted with 342 lbs/ton ferric chloride and 670 lbs/ton (23.4 active lbs/ton @3.5% active) of C-341 Mannich polymer. Cake dryness of 24±2% TS can be anticipated based upon the centrifuge spin down test results.

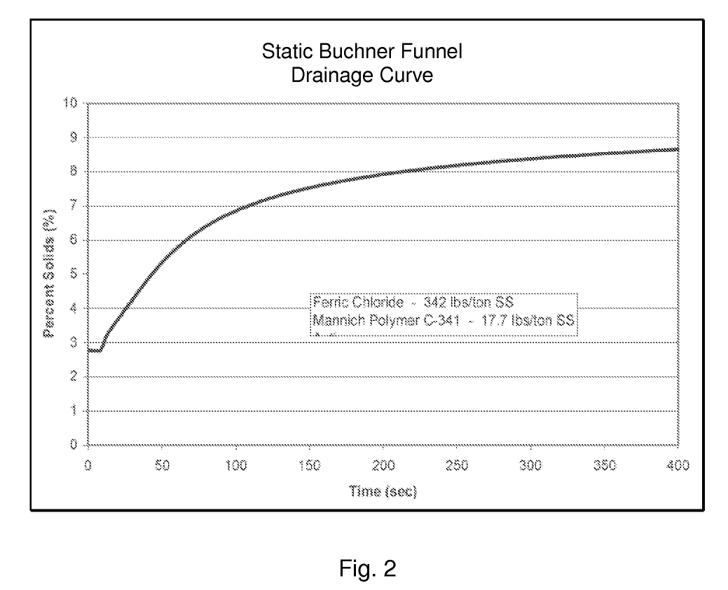

Static Buchner funnel drainage curves were conducted to determine the achievable discharge solids from an Andritz belt press. Discharge solids of 7-9% TS can be anticipated from an Andritz belt press. A drainage curve is shown in FIG. 2.

Industrial Fabrics Corporation 6093 is one recommended filter fabric for the sample received. Suitable filter fabric releases the solids after filtering.

The sludge sample rated a 5 on the Andritz Abrasivity Index where 1 is the least abrasive and 10 is the most abrasive.

The raw sludge sample “A” was analyzed and had the following characteristics:

A. Sample Analysis

| | |
|---|---|
| Total Solids (% TS @ 105° C.) | 2.90 |
| Suspended Solids (% SS @ 105° C.) | 2.24 |
| pH @ 21° C. | 7.9 |
| Specific Gravity | 1.0 |
| Ash Content of Total Solids (% of TS) | 33.5 |
| Capillary Suction Time (sec) | 1184.7 |

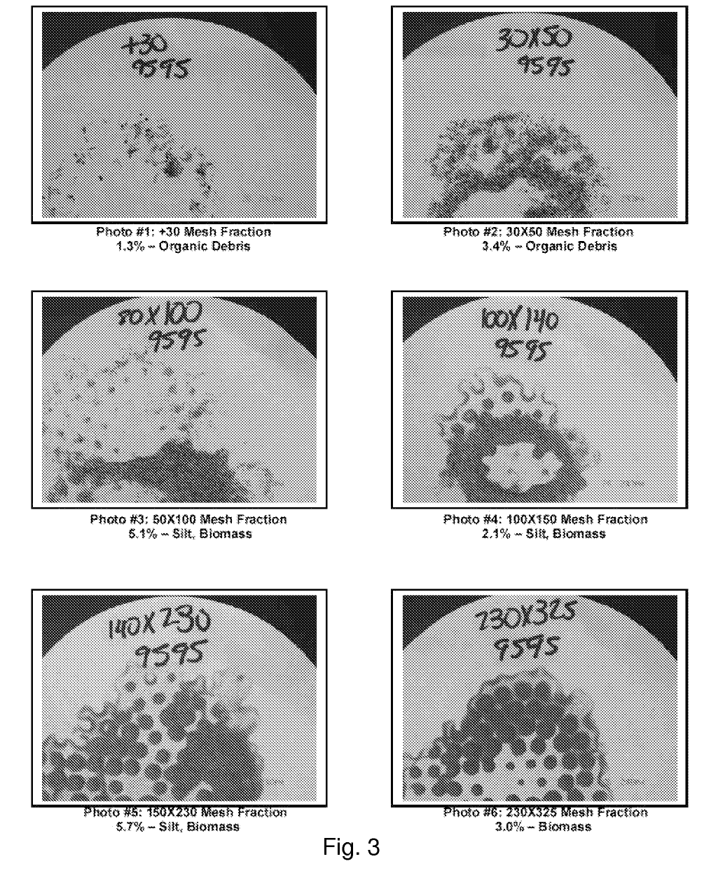

The screened solids from the raw sludge sample “A” based upon particle size is described below and shown in FIG. 3.

| Screened Solids: | | Description |
|---|---|---|
| +30 Mesh Fraction (% of SS) | 1.3 | Organic |
| | | Debris |
| 30 × 50 Mesh Fraction (% of SS) | 3.4 | Organic |
| | | Debris |
| 50 × 100 Mesh Fraction (% of SS) | 5.1 | Silt, Biomass |
| 100 × 140 Mesh Fraction (% of SS) | 2.1 | Silt, Biomass |
| 140 × 230 Mesh Fraction (% of SS) | 5.7 | Silt, Biomass |
| 230 × 325 Mesh Fraction (% of SS) | 3.0 | Biomass |
| −325 Mesh Fraction (% of SS) | 79.6 | |
| Sludge Volume Index (SVI) | 44 | |
| Settled Solids (1000 ml @ 30 min) | 1000 | |
| Color | | Brown |
| Odor | | Cow Manure |

B. Polymers Tested

| | |
|---|---|
| Ashland: K279FLX, K290FL | Ciba: 8814, 8818, 8868FS |
| Polydyne: C-9530, C-6267 | Water Solutions: C-341, Super Alta |

C. Test Results

| Test Temperature (° F.) | |
|---|---|
| Chemical Conditioner | Ferric Chloride |
| Chemical Dosage Rate (lbs/ton SS) | 342 |
| Recommended Polymer | Water Solutions C-341 |
| Makeup Polymer Dilution (%) | 5.0 |
| Injection Polymer Dilution (%) | 5.0 |
| Neat Polymer Dosage (lbs/ton SS) | 353.7 |
| Active Polymer Dosage | 17.7 |
| (3.5% Active) (lbs/ton SS) | |
| Recommended Belt Type IFC 6093 | 1.0 m SMX ®-S8 |
| BFP Type | |
| Throughput (lb TS/hr) | 634 |
| Throughput (GPM) | 56 |
| Solids Capture (% SS ± 1%) | 95 |
| Belt Speed (FPM) | 12 |
| Cake Thickness (mm) | 7 |
| Cake Solids (% TS) | 18.4 |

Centrifuge Test Results

| | | Ferric | Polymer | | |
|---|---|---|---|---|---|
| Spin | Type | Chloride | Dosage | Plug | Anticipated |
| Time | Of | Dosage Rate | Rate (active | Solids | Cake Solids |
| (Minutes) | Test | (lbs/ton SS) | lbs/ton) | (% TS) | (% TS) |
| 5 | Glass | None | 23.4 | 11.1 | 24 ± 2 |
| | Tube | | | | |
| 5 | Glass | 342 | 23.4 | 11.2 | |
| | Tube | | | | |
| 10 | Screen | 342 | 23.4 | 22.2 | |
| 15 | Screen | 342 | 23.4 | 26.1 | |
| 20 | Screen | 342 | 23.4 | 26.3 | |

The sample received was light brown in color and emitted a strong cow fecal odor. The suspended solids were 2.24% SS and the ash content was 33.5%. The sample contained a high amount of dissolved solids at 0.66% and a high capillary suction time at 1184.7 seconds. Capillary suction time is usually indicative of the ability of sludge to release water. Capillary suction times higher than 500 seconds require high polymer dosage rates, pH adjustment or chemical conditioning.

The sample required ferric chloride to flocculate the sludge. Ferric chloride at 38.4% solution and 1.392 S.G. was used. The polymer supplied would not flocculate the sludge alone at any dosage rate. The sludge needs to be conditioned prior to the use of flocculation. This is typical of any animal manure sludge sample.

Table 2A and 2B, are analytical data supportive of the clarity, contaminate removal (of the post phase one solids removal) where the “Pre Treat” portion is the actual liquid received from the effluent liquid portion of the phase one treatment and the “Post Treat” data is the phase two treatment data. Table 2A shows the metal reductions (or slight increases) from the addition of the chemistries only from the addition of the chemistry and no data was available from post one and two pass bentonite clay treatments.

TABLE 2A
Demonstrated Results - Metals Reduction

| | Pre Treat | Post Treat | Units |
|---|---|---|---|
| Aluminum, Al | 133 | 444 | ug/L |
| Antimony, Sb | <100 | <100 | ug/L |
| Arsenic, As | <100 | <100 | ug/L |
| Barium, Ba | <50 | 486 | ug/L |
| Beryllium, Be | <10 | <10 | ug/L |
| Boron, B | 1,150 | 197 | ug/L |
| Cadmium, Cd | <5 | <5 | ug/L |
| Calcium, Ca | 337,000 | 56,100 | ug/L |
| Chromium, Cr | <50 | <50 | ug/L |
| Cobalt, Co | 84 | 81 | ug/L |
| Copper, Cu | 41 | <10 | ug/L |
| Iron, Fe | 29,800 | 194 | ug/L |
| Lead, Pb | 133 | <50 | ug/L |
| Magnesium, Mg | 461,000 | 366,000 | ug/L |
| Manganese, Mn | 13,300 | 952 | ug/L |
| Molybdenum, Mo | <50 | 214 | ug/L |
| Nickel, Ni | 85 | 63 | ug/L |
| Potassium, K | 988,000 | 700,000 | ug/L |
| Selenium, Se | <100 | 126 | ug/L |
| Silicon, Si | 27,500 | 19,200 | ug/L |
| Sodium, Na | 665,000 | 676,000 | ug/L |
| Thallium, Tl | <100 | <100 | ug/L |
| Titanium, Ti | <100 | <100 | ug/L |
| Vanadium, V | <50 | <50 | ug/L |
| Zinc, Zn | 143 | 55 | ug/L |

In Table 2B, the Post Treat 2A is the effluent liquid put directly over bentonite clay for ammonia removal and the Post Treat 2B is a two pass removal over bentonite clay, showing both the Total Kjeldahl Nitrogen (TKN) removal as well as the ammonia reductions from the 2 pass system. It is significant to note that ammonia content was reduced to 134 mg/L. This surprisingly low ammonia content may enable the water to be passed through a reverse osmosis treatment process to further remove the ammonia and render it more usable for various recycling applications, including animal watering.

TABLE 2B
Demonstrated Results - Additional Treatment Data

| | Pre | Post | Post- | Post- | |
|---|---|---|---|---|---|
| | Treat | Treat | Treat 2A | treat 2B | |
| Nitrate (as N) | 0.2 | <0.2 | | | mg/L |
| Ammonia Direct | 1,140 | 980 | 195 | 134 | mg/L |
| (as N) | | | | | |
| Nitrate + Nitrite (as N) | 0.3 | 0.2 | | | mg/L |
| Nitrite (as N) | 0.11 | 0.05 | | | mg/L |
| Nitrogen, Total | 1,180 | 912 | | 124 | mg/L |
| Kjeldahl (TKN) | | | | | |
| Total Nitrogen | 1,180 | 912 | | 124 | mg/L |
| Total Phosphate (as P) | 1.3 | 0.09 | | | mg/L |
| Chemical Oxygen | >1,900 | 508 | | | mg/L |
| Demand | | | | | |
| Sulfate, SO4 | 129 | 612 | | | mg/L |
| Biochemical Oxygen | 1,690 | <69 | | | mg/L |
| Carbon, Total Organic, | 725 | 76 | | | mg/L |
| TOC | | | | | |
| Sulfite | 5 | <5 | | | mg/L |
| Total Suspended | 244 | 44 | <10 | <3 | mg/L |
| Solids | | | | | |

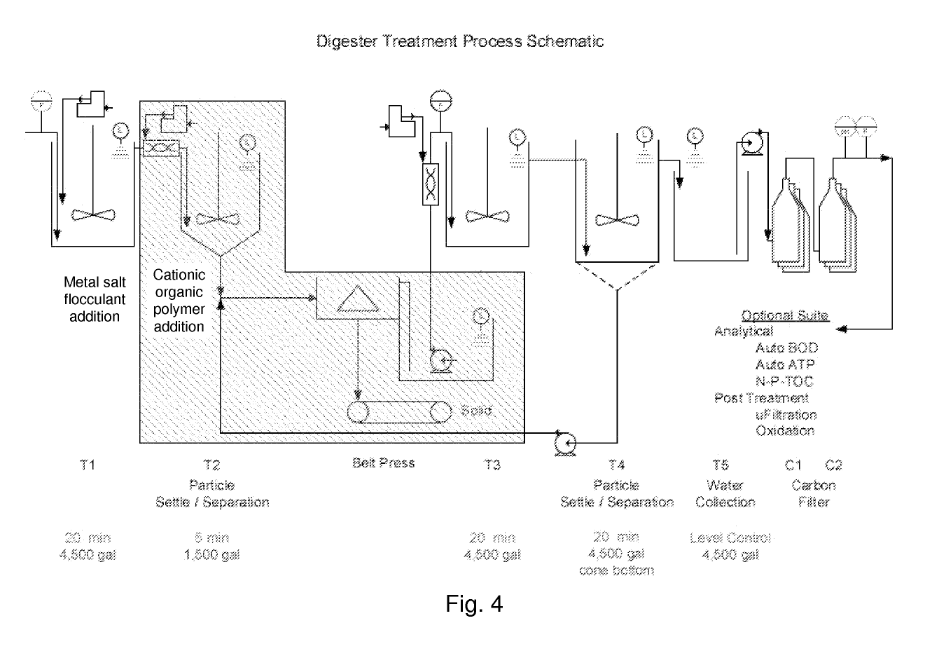

FIG. 4 shows one possible non-limiting configuration (schematic) for the treatment system.

“Carbon Credits” Obtained by the Treatment of Post Anaerobic Digester Effluent

Greenhouse gases are components of the atmosphere that increase the atmosphere's ability to trap infrared energy and contribute to so-called global warming. Some important greenhouse gases due to human activity include carbon dioxide, methane, nitrous oxide, and hydrofluorocarbons (HFCs). Major sources of carbon dioxide include burning of fossil fuels and deforestation. Major sources of methane are livestock, paddy rice farming, and covered vented landfill emissions.

Methane accounts for about 16% of global greenhouse-gas emissions, according to the International Energy Agency. That is far less than the most prevalent greenhouse gas, CO₂, which accounts for 75% of the global total. However, methane is a more potent greenhouse gas, that is, it has a higher global warming potential (GWP) compared to carbon dioxide. The GWP depends on both the efficiency of the molecule as a greenhouse gas and its atmospheric lifetime. GWP is measured relative to the same mass of CO₂ and evaluated for a specific timescale. Methane has an atmospheric lifetime of 12±3 years and a GWP of 62 over 20 years, 23 over 100 years and 7 over 500 years. The decrease in GWP associated with longer times is associated with the fact that the methane is degraded to water and CO₂ by chemical reactions in the atmosphere.

With increasing awareness of the need to reduce emission of greenhouse gases, new markets have developed to trade “carbon credits.” One carbon credit is defined to be the equivalent of the emission of one metric tonne of CO₂ per year into the atmosphere. Technology and processes and that eliminate greenhouse gas emissions may be able to claim the “carbon credit” equivalent to the eliminated greenhouse gas emission.

Eliminating methane emission is attractive because methane is such a potent greenhouse gas. As an example, the methane produced by the manure of a typical 1,330-pound cow is equivalent to about five metric tonnes of CO₂ per year. That is about the same amount generated annually by a typical U.S. car, one getting 20 miles per gallon and traveling 12,000 miles per year.

In the case of cow manure, carbon credits may be claimed by capturing or destroying “volatile solids” that otherwise would produce and release methane into the atmosphere. For example, a cow weighing 1,330 lbs. produces about 115 lbs. of manure a day. Of that manure, about 11 lbs. are considered “volatile solids” which produce about 1 cubic meter of methane per day, or 365 cubic meters of methane per year. This amount of methane is equivalent to about 5 metric tonnes of CO₂ emissions per year or 5 CO₂ credits per year. See, “Cows, Climate Change and Carbon Credits,” The Wall Street Journal Online, http://online.wsj.com/article/SB118178859139934868.html.

The disclosed invention captures volatile solids and prevents them from forming methane that otherwise would be released into the atmosphere. Therefore, to the extent the disclosed process captures methane-producing solids, the disclosed process generates carbon credits equivalent to the methane generating potential of the captured solids.

While specific embodiments of the present invention have been illustrated and described, numerous modifications come to mind without significantly departing from the spirit of the invention, and the scope of protection is only limited by the scope of the accompanying claims.

1. A process for treating a liquid fraction of effluent wastewater from post anaerobic digestion comprising:
adding a metal salt flocculant to the liquid fraction in an amount ranging from about 50 to 500 ppm in the liquid fraction, wherein the metal salt flocculent is selected from inorganic iron and aluminum flocculent compounds having a +2 or +3 valence;
adding a cationic organic polymer to the liquid fraction in an amount ranging from about 10 to about 150 ppm in the liquid fraction, wherein the cationic organic polymer has a molecular weight greater than about 3,000,000 and a cationicity in the range form 1.25 mole % to 30 mole %, and wherein the metal salt flocculent and the cationic organic polymer produce a separable solid fraction in the liquid fraction; and
removing the separable solid from the liquid fraction to form a treated liquid fraction.

2. The process for treating a liquid fraction according to claim 1, further comprising the step of passing the treated liquid fraction through carbon filter.

3. The process for treating a liquid fraction according to claim 1, further comprising the step of passing the treated liquid fraction through activated bentonite clay.

4. The process for treating a liquid fraction according to claim 1, wherein the metal salt flocculent is selected from polyaluminum chloride (PAC), aluminum chlorohydrate, aluminum sulfate, calcium aluminate, aluminum and sodium silicates, ferrous and ferric chlorides and sulfates, and analogs thereof.

5. The process for treating a liquid fraction according to claim 1, wherein the metal salt flocculent is an from inorganic aluminum flocculent compounds having a +3 valence.

6. The process for treating a liquid fraction according to claim 1, wherein the cationic organic polymer includes a dimethyl nitrogen-based quaternary moiety to provide its cationicity.

7. The process for treating a liquid fraction according to claim 1, wherein the cationic organic polymer is selected from polyacrylamide, Mannich polymers, diallyl dimethyl ammonium chloride (DADMAC), epi-dma, and mixtures thereof.

8. The process for treating a liquid fraction according to claim 1, wherein the cationic organic polymer is dry.

9. The process for treating a liquid fraction according to claim 1, wherein the cationic organic polymer has a cationicity in the range form 1.25 mole % to 20 mole %.

10. The process for treating a liquid fraction according to claim 1, wherein the cationic organic polymer has a cationicity in the range form 1.25 mole % to 10 mole %.

11. The process for treating a liquid fraction according to claim 1, wherein the cationic organic polymer has a cationicity in the range form 1.25 mole % to 5 mole %.

12. The process for treating a liquid fraction according to claim 1, wherein the cationic organic polymer has a cationicity in the range form 1.25 mole % to 2.5 mole %.

13. The process for treating a liquid fraction according to claim 1, wherein the cationic organic polymer has a molecular weight greater than 5,000,000.

14. The process for treating a liquid fraction according to claim 1, wherein the separable solid fraction is separated from the liquid fraction by a mechanical separation technique.

15. The process for treating a liquid fraction according to claim 14, wherein the mechanical separation technique is selected from belt press, centrifuge, or filter press.

16. The process for treating a liquid fraction according to claim 1, wherein the metal salt flocculant is added to the liquid fraction in an amount ranging from about 150 to 250 ppm in the liquid fraction

17. The process for treating a liquid fraction according to claim 1, further comprising the step of adding a pre-treatment cationic organic polymer to the liquid fraction prior to the step of adding the metal salt flocculant to the liquid fraction.

18. The process for treating a liquid fraction according to claim 17, wherein the pre-treatment cationic organic polymer is added to the liquid fraction in an amount ranging from about 20 to 30 ppm in the liquid fraction, wherein the pre-treatment cationic organic polymer has a molecular weight greater than about 3,000,000 and a cationicity in the range form 1.25 mole % to 30 mole %.

19. The process for treating a liquid fraction according to claim 17, wherein the pre-treatment cationic organic polymer and the cationic organic polymer comprise the same polymer.

20. The process for treating a liquid fraction according to claim 17, wherein the metal salt flocculent is added to the liquid fraction in an amount ranging from about 50 to 75 ppm in the liquid fraction.

21. A process for treating a liquid fraction of effluent wastewater from post anaerobic digestion containing fine solids having a size less than about 25 microns comprising:
adding a cationic organic polymer to the liquid fraction in an amount ranging from about 10 to about 30 ppm in the liquid fraction, wherein the cationic organic polymer has a molecular weight greater than about 3,000,000 and a cationicity in the range form 1.25 mole % to 30 mole %, and wherein the cationic organic polymer and fine solids produce a separable fine solid fraction in the liquid fraction;
removing the separable fine solid fraction from the liquid fraction;
adding a metal salt flocculent to the liquid fraction in an amount ranging from about 50 to 100 ppm in the liquid fraction, wherein the metal salt flocculant is selected from inorganic iron and aluminum flocculant compounds having a +2 or +3 valence;
adding a cationic organic polymer to the liquid fraction in an amount ranging from about 10 to about 150 ppm in the liquid fraction, wherein the cationic organic polymer has a molecular weight greater than about 3,000,000 and a cationicity in the range form 1.25 mole % to 30 mole %, and wherein the metal salt flocculant and the cationic organic polymer produce a separable solid fraction in the liquid fraction; and
removing the separable solid from the liquid fraction to form a treated liquid fraction.

22. The process for treating a liquid fraction according to claim 21, further comprising the step of passing the treated liquid fraction through carbon filter.

23. The process for treating a liquid fraction according to claim 21, further comprising the step of passing the treated liquid fraction through activated bentonite clay.

24. The process for treating a liquid fraction according to claim 21, wherein the metal salt flocculant is an from inorganic aluminum flocculant compounds having a +3 valence.

25. The process for treating a liquid fraction according to claim 21, wherein the cationic organic polymer is selected from polyacrylamide, diallyl dimethyl ammonium chloride (DADMAC), epi-dma, and mixtures thereof.
